(19) United States
(12) Patent Application Publication
(10) Pub. No.: US 2018/0330080 A1
(43) Pub. Date: Nov. 15, 2018

(54) ISOLATED REMOTELY-VIRTUALIZED MOBILE COMPUTING ENVIRONMENT

(71) Applicant: Intel Corporation, Santa Clara, CA (US)

(72) Inventors: Yao Zu Dong, Shanghai (CN); Xiao Zheng, Shanghai (CN); Yulei Zhang, Shanghai (CN)

(21) Appl. No.: 15/777,402

(22) PCT Filed: Dec. 22, 2015
(86) PCT No.: PCT/CN2015/098264

§ 371 Date: May 18, 2018

(51) Int. Cl. G06F 21/53; H04M 1/725; G06F 21/60; H04L 29/06; H04W 12/10

(52) U.S. Cl. CPC G06F 21/53; H04M 1/72577; G06F 2221/2149; H04L 63/18; H04W 12/10; G06F 21/602

(57) ABSTRACT

Isolated remotely-virtualized computing environment for a mobile device. The mobile device is configured to connect with a virtualized mobile system (VMS) implemented on a remote server. The mobile device accesses local input information via a local input device and a local OS, and transmits the local input information to the VMS. The mobile device further accesses output information from the VMS and passes the output information to be accessed by an output device, such as a display, for instance. Isolation of the output information is maintained where the content of the output information is inaccessible by the OS and the local processes running on the mobile device.

### TECHNICAL FIELD

Embodiments described herein generally relate to information processing and security and, more particularly, to providing a secure computing environment in a mobile computing device.

### BACKGROUND

Mobile computing devices, such as smartphones, tablets, and the like, have rapidly become commonplace as personal accessories, and not merely tools for business or professional use. As such, employees of companies or other enterprises oftentimes will make use of their own personal devices to perform certain business-related tasks, such as the use of email or other business communications, maintaining contacts and calendar events, viewing or editing documents, and the like, alongside personal, non-business activities such as playing games, social networking, Web browsing, downloading apps, etc. Likewise, in the case of enterprise-issued devices to employees, the employees will naturally tend to make some personal use of those devices.

In general, combining personal and business use of the same device increases the risk of harm to the business. Critical information in the form of files, messages, access credentials, or other data meant to be kept confidential may be exposed to individuals outside of a trusted group, either inadvertently by the user, or by a malicious entity such as by operation of malware such as worms, Trojans or viruses, phishing, network intrusion, or other hacker attack. Malware that may compromise the kernel of the mobile device's operating system may be particularly worrisome, since many conventional security measures rely on the integrity of the operating system's protection architecture.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a high-level system block diagram illustrating an example system arrangement according to some embodiments.

FIG. 2 is a block diagram illustrating an example mobile device featuring multiple computational environments according to some embodiments.

FIG. 3 is a block diagram illustrating an example system architecture of a mobile device configured to implement the multiple computational environments described in connection with the embodiments of FIG. 2.

FIG. 4 is a block diagram illustrating an example arrangement of the computing hardware depicted in FIG. 3.

FIG. 5 is a block diagram illustrating the security engine of the mobile device depicted in FIG. 3 according to some embodiments.

FIG. 6 is a block diagram illustrating an example system architecture of a mobile device, as well as example functionality and information flow according to some embodiments.

FIG. 7 is a flow diagram illustrating an example process for operation of a mobile device according to some embodiments.

### DETAILED DESCRIPTION

Certain aspects of the embodiments are directed to configuring a mobile device to present multiple computational environments that are isolated from another. In some embodiments, the isolation is achieved while making use of the hardware and certain operating system functionality, such as device drivers, binary scan, etc., of the mobile device for each of the multiple computational environments. In various embodiments, there may be two, or more than two, multiple computational environments.

Various applications, without limitation, are contemplated for the multiple environments. For instance, one environment may be for personal use, while the other may be for secure operations. Secure operations in this example may be business use, parental mode, or more generally, any operations that benefit from being isolated from the one or more other environments.

In some embodiments, the local computational environment constitutes the hardware platform, system software, and applications that are native to the mobile device, while a second computational environment (and, optionally, additional computational environments) are each implemented using a virtualized mobile system (VMS) executed on a remote computing device, such as a server. These non-native one or more computational environments may therefore be regarded in a general sense as a type of thin-client virtualized desktop, except that various embodiments achieve a secure isolation of at least a part of the content delivered to the mobile device by the VMS from the operating system and other processes of the mobile device.

Conventionally, remote-desktop and other thin-client applications rely on the integrity of their host operating system kernel to be free from malware. Although a secure communications channel may deliver encrypted data between the thin-client application and the remote desktop running on a remote server, at some point the delivered data is decrypted and stored on the client device under the control of the operating system. A compromised operating system kernel may grant unauthorized access to the stored un-encrypted content. Even in the case of an un-compromised operating system, the user of the device may nonetheless violate the security of the remote desktop session. One example of such an action is taking a screenshot of the displayed graphics of the thin-client application, which results in an image, of what was supposed to be secure content exchanged between the server and the thin client application, being saved in the user space of the local operating system.

According to some embodiments, a system for implementing an isolated remotely-virtualized computing environment on a mobile device includes computing hardware, including a processing system (including a data store), an input device, an output device, and a network interface device (NID). The computing hardware is programmed to execute a local operating system (OS) to control execution of local processes. The computing hardware is additionally configured to provide an isolated computing environment engine. In various embodiments, the isolated computing environment engine is realized using hardware components from among the local computing hardware, as well as firmware or software components, that are to be executed on the local computing hardware, including input/output device drivers, other operating system components, and one or more applications that work together to carry out the functionality of the isolated computing environment engine.

The isolated computing environment engine is operative to facilitate a connection with a VMS implemented on a remote server; access local input information via the input device and the local OS, and transmit the local input information via the NID to the VMS; and access, via the NID, output information from the VMS and pass the output information to be accessed by the output device. Notably, the isolated computing environment engine is operative to maintain isolation of the output information in such a way that content of the output information is inaccessible by the OS and the local processes.

In the present context, the term local input information means information accessed via a local input device of the mobile device. The local input information is also supplied as an input to the VMS. It should be noted that, as the local input information is sent from the mobile device to the VMS (in which case it would constitute an output from the mobile device), the sent information remains a product of the local input device, and is always referred to as local input information herein for the sake of consistency. Likewise, the term output information means information generated by the VMS to be sent to the mobile device, and to be output by the mobile device via one or more local output devices, such as display, sound, and LED indicator devices, for instance. Although during the sending of the output information to the mobile device the output information may constitute an input into the mobile device, the information being received by the mobile device remains information to be output by the local output device(s) of the mobile device, and is consistently referred to as output information herein.

In a related embodiment, the output information from the VMS includes streaming graphical display content, such as a video stream and metadata. In related embodiments, the output information may also include streaming audio content, haptic output (e.g., vibration), display backlight intensity information, light-emitting diode (LED) control information, and the like. In these embodiments, the output information may include content from a remote operating system shell executed on the VMS. The operating system shell on the VMS may be for an operating system that is optimized for a mobile device, such as an Android™, iOS™ or Windows™ Mobile operating system.

In some embodiments, the local input information includes touchscreen input, and input from buttons of the mobile device. In related embodiments, the local input information may also include information from sensors of the mobile device such as camera, microphone, motion, geographic position, biometrics, magnetometer, and the like. In other related embodiments, the local input information may also include information from accessory devices interfaced with the mobile device, such as information from a paired smartwatch, heartrate monitor, remote headset, and the like, which may be interfaced via a wireless personal area network such as Bluetooth™.

In a related type of embodiment, the local input information may be isolated from the local operating system and other processes of the mobile device using similar techniques as are used for isolating the output information from the VMS server.

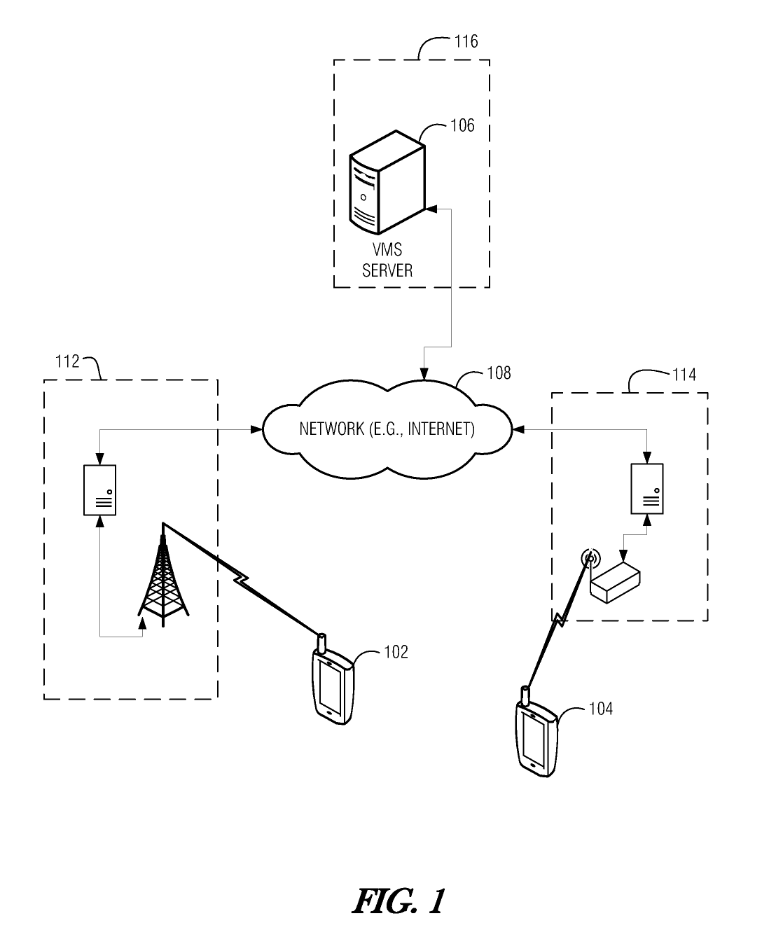

FIG. 1 is a high-level system block diagram illustrating an example system arrangement according to some embodiments. Mobile device 102 and mobile device 104 are each configured to perform local operations to facilitate a connection to VMS server 106 over their respective local networks service providers, and over a wide-area network 108, such as the Internet. As depicted, mobile device 102 connects via service provider 112, which may operate a cellular service such as a long-term evolution (LTE)-based system, for example. Mobile device 104 connects to network 108 via service provider 114, which provides Internet connectivity via cable, DSL, fiber, or other suitable medium. The connection between mobile device 104 and service provider 114 may include a wireless connection via a Wi-Fi access point. VMS server 106 connects to network 108 via service provider 116.

Mobile devices 102 and 104 may be smartphones, as depicted in FIG. 1 and as described in the example embodiments herein for the sake of brevity. However, it will be understood that a smartphone is representative of other types of the mobile devices, which may have more or fewer features.

Each mobile device 102, 104 may have a touchscreen, which may form a part of the overall enclosure of device in cooperation with a housing. The touchscreen includes hardware that functions as an output device (e.g., an LED screen for visual display, power and controller circuitry, etc.), and an input device generally layered over the visual display and formed from a suitable touch-sensitive technology (e.g., capacitive, resistive, optical, ultrasonic, etc.), along with the corresponding detection and power circuitry.

Additionally, each mobile device 102, 104 includes one or more user-operable input devices, such as button(s), keypad, keyboard, trackpad, mouse, etc.

Each mobile device 102, 104 may have several sensing transducers, the physical stimulation of which produces signaling that may be sampled, digitized, and stored as captured data. For instance, the sensing transducer may include a camera having an image sensor, along with additional hardware for digitizing, processing, and storing portions of the image sensor output. The camera may record still images, motion video, or both.

The sensing transducers may also include a microphone and corresponding audio capture circuitry that samples, digitizes, and stores portions of the signaling produced by the microphone in response to sensed acoustic stimulus. The microphone is typically activated together with the camera when the mobile device is operated to record videos.

Other types of sensing transducers commonly found in mobile devices such as mobile devices 102 and 104 are a global positioning system (GPS) receiver having an antenna and radio receiver circuitry to receive multiple signals being broadcast by a constellation of Earth-orbiting satellites, along with processing circuitry to discern the current position on the Earth of the mobile device; an accelerometer having a multi-axis sensor that produces signaling in response to changes in motion, and electronics to sample and digitize that signaling; a magnetometer having sensors and supporting circuitry that detect the direction and intensity of the ambient magnetic field, or any externally-applied magnetic fields; and a biometric sensor having an array of sensors for measuring a biometric indicator, such as a user's fingerprint, along with supporting circuitry.

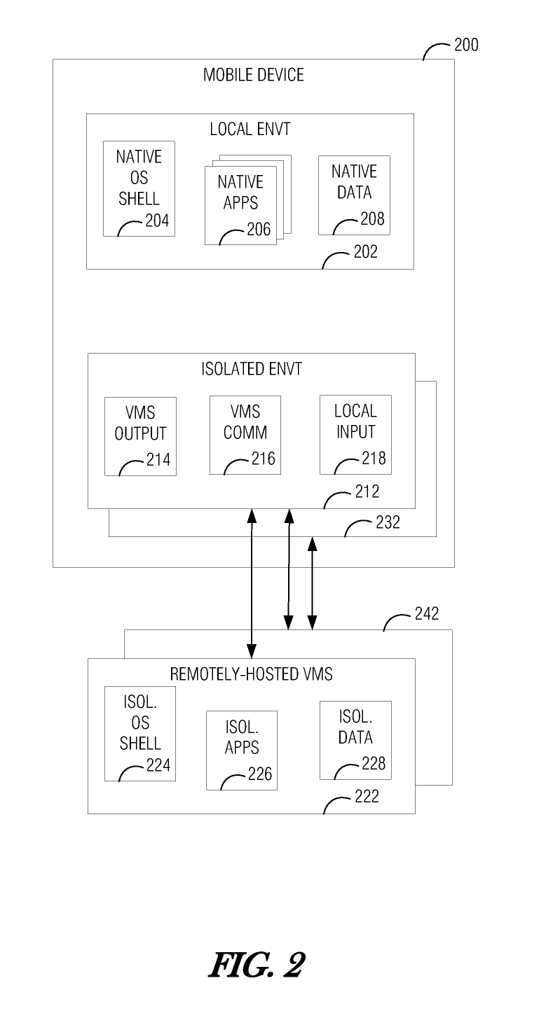

FIG. 2 is a block diagram illustrating an example mobile device featuring multiple computational environments according to some embodiments. Mobile device 200 includes various engines, which are described below. The term engine in the present context is a structural descriptor for hardware, software, or firmware communicatively coupled to one or more processors in order to carry out corresponding operations. Engines may be hardware engines and, as such, engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more hardware processors may be configured by ROM, firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time.

As depicted, mobile device 200 has local computational environment engine 202 and isolated computational environment engine 212. Local computational environment 202 presents a native OS shell 204 to the user, along with native applications 206 and native data 208. In this example, the native OS shell 204, native applications 206, and native data 208 reside on the mobile device 200, meaning that they are stored and executed on mobile device 200.

Isolated computational environment 212 includes VMS output engine 214, VMS communication engine 216, and local input engine 218. VMS communication engine 216 is programmed, or otherwise configured, to communicate with remotely-hosted VMS 222 to establish a communication session and exchange input and output information. VMS output engine 214 is programmed, or otherwise configured, to access display information, such as a frame buffer stream, sound, lights, haptic output, and any other output information from remotely-hosted VMS 222, to be presented to the user of mobile device 200 by operation of the facilities of mobile device 200, and to pass each type of the output information to the appropriate facility of mobile device 200. Local input engine 218 is programmed, or otherwise configured, to access data generated by sensed touchscreen gestures microphone, camera, position, orientation, biometric, and other local input information generated by mobile device 200, and transmit the local input information the remotely-hosted VMS 222. Notably, isolated computational environment engine 212 maintains isolation of at least a portion of the output information from local environment engine 222. For example, the display and sound information may be isolated from local environment 202, but the haptic output may not be isolated. In a related embodiment at least a portion of the local input information to be transmitted to remotely-hosted VMS 222 is kept isolated from local environment engine 202.

Remotely-hosted VMS 222 hosts isolated OS shell 224, along with isolated applications 226, and isolated data 226. These may be executed on one of multiple system virtual machines that are hosted on the remote server. In some embodiments, the virtual machines virtualize an entire mobile device of the same (or similar) type as mobile device 200 so that, when the user of mobile device 200 is interacting with isolated computational environment engine 212 the user experiences similar, familiar, operability as when the user interacts with local environment engine 202.

In a related embodiment, mobile device 200 is configured to support more than one isolated computational environment engine, as depicted with the presence of second isolated computational environment engine 232. Second isolated computational environment engine 232 may be used concurrently with isolated computational environment engine 212 to facilitate an additional isolated computational environment that may be isolated from isolated computational environment engine 212 as well as from local environment engine 202. Although not depicted in FIG. 2 for the sake of clarity, it will be understood that second isolated computational environment engine 232 may include a corresponding VMS output engine, VMS communication engine, and local input engine. Second isolated computational environment engine 232 may perform local operations to facilitate a connection with a second remotely-hosted VMS 242 as depicted. Second remotely-hosted VMS 242 will be understood to include a second set of an isolated OS shell, isolated applications, and isolated data to be presented to second isolated computational environment 232.

In another related embodiment, second remotely-hosted VMS 242 may be connected with by isolated computational environment 212 in a communication session. In some embodiments, the user of mobile device 200 may, via VMS communication engine 216, select the remotely-hosted VMS with which to establish a communication session. In another related embodiment, isolated computational environment 212 is adapted to support simultaneous connectivity with more than one remotely-hosted VMS. In this arrangement, the multiple remotely-hosted VMSs are not isolated from one another, though they are each isolated from local environment engine 202.

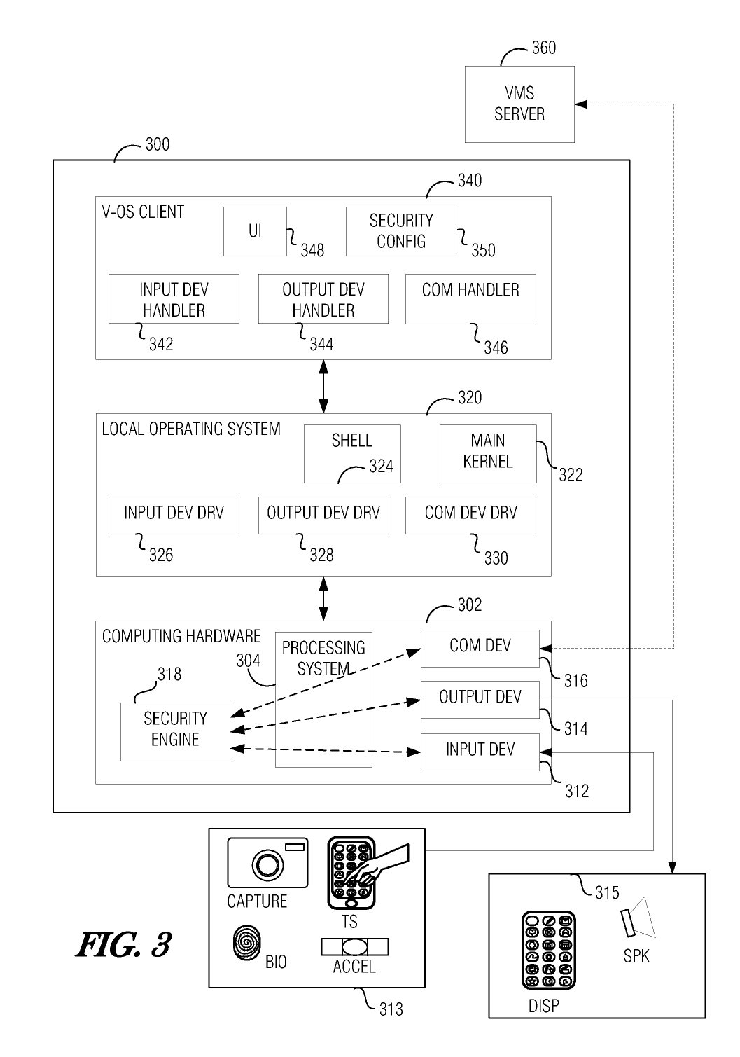

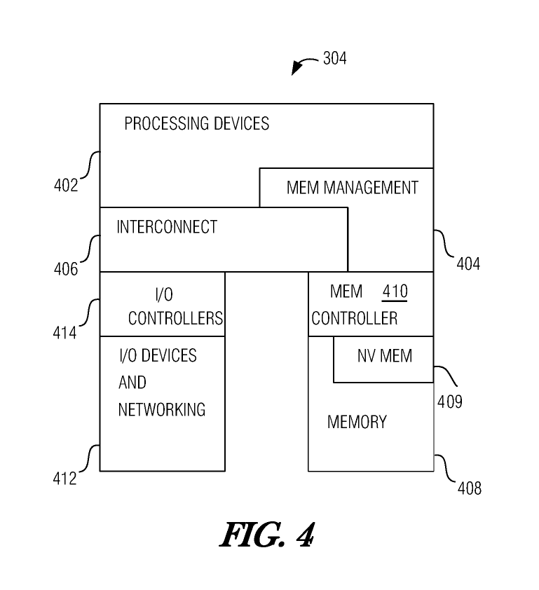

FIG. 3 is a block diagram illustrating an example system architecture of a mobile device configured to implement the multiple computational environments described in connection with the embodiments of FIG. 2. As depicted in FIG. 3, mobile device 300 is constructed to include computing hardware 302. Computing hardware 302 includes processing system 304, which is described in greater detail below with reference to FIG. 4. Computing hardware 302 also includes input device interface 312, output device interface 314, and communication device 316, as well as security engine 318.

Input device interface 312 contains circuitry configured to receive signaling generated by sensing transducers 313 such as, for example, a touchscreen panel, image and sound capture devices, biometric sensor, accelerometer, and the like, and convert the signaling to digital data and transfer the data to be read by processing system 304. Output device interface 314 contains circuitry configured to transfer output information from processing system 304 to output devices 315, such as a display panel, speaker, vibration generator, lights, or the like. Output device interface 314 may include one or more converters of data, such as a High-bandwidth Digital Content Protection (HDCP) converter circuit, a High-Definition Multimedia Interface (HDMI), a Mobile Industry Processor Interface (MIPI), an Embedded DisplayPort (eDP) converter interface, and the like. Communication device 316 includes the interface circuitry, e.g., modem, and radio circuitry to provide wireless communications such as LTE-based communications, Wi-Fi, and the like, to provide a communications link with VMS server 360.

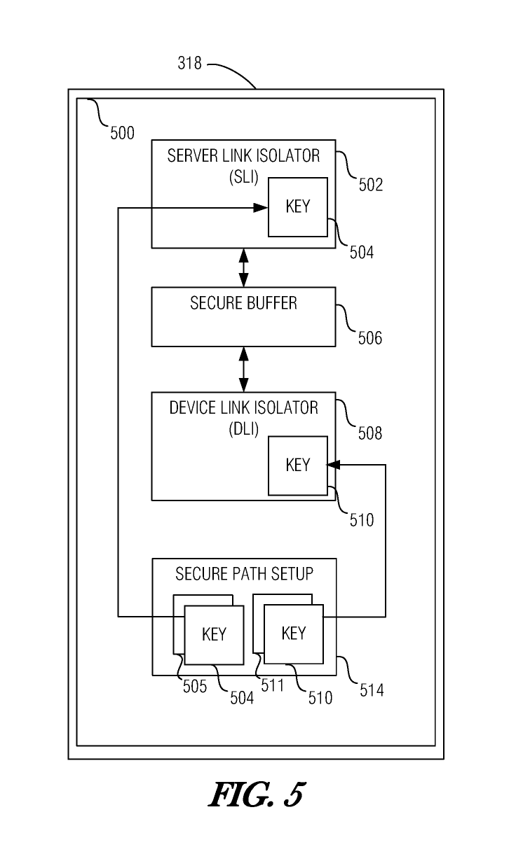

Security engine 318 includes circuitry programmed, or otherwise configured, to ensure isolation from the local operating system and other processes executing on processing system 304 of at least the output information exchanged with VMS server 360. Security engine 318 is described in greater detail below with reference to FIG. 5.

Local operating system 320, in various embodiments, may be an Android™ iOS™, Windows Mobile™-based mobile operating system, or another suitable operating system adapted for execution on mobile device 300. In general, local operating system 320 includes main kernel 322, which handles process scheduling and management, memory management, and myriad other essential system-level tasks. Shell 324 provides a local graphical user interface (GUI) for the user, with access to setting or modifying various operational parameters of local OS 320, installing and launching applications, and generally providing other user-interactive functionality for controlling mobile device 300. Input device drivers 326, output device drivers 328, and communication device drivers 330 are components of local OS 320 that provide access to the input, output, and communication devices of the computing hardware 302.

Virtual OS client 340 is an application that is executed on computing hardware 302 under control of local operating system 320. In the embodiment depicted, virtual OS client 340 includes an input device handler component 342 that reads the input data generated by operation of input devices 313, and passes it to communication handler component 346, which operates to communicate the input information to VMS server 360. Output device handler 344 is a component that transfers output information received from VMS server 360 via communication handler 346 to be output on output devices 315. Communication handler 346, in addition to coordinating the input and output information communications described above, also operates to establish communication sessions with VMS server 360 (or other VMS server(s)—not shown). User interface 348 provides user-operable controls for configuring one or more operational parameters of virtual OS client 340, including selection of VMS server 360 from among other available servers, setting user preferences for behavior of mobile device 300 as it executes an isolated computational environment, selection of input devices of the local mobile device to interface with the VMS, local output device settings that override the VMS output, and other such functionality. Security configuration block 350 represents such functions as user authentication, coordination of the exchange of cryptographic keys, authenticating VMS server 360, and the like.

FIG. 4 is a block diagram illustrating an example arrangement of the computing hardware depicted in FIG. 3. Processing system 304 includes processing devices 402 (which may include one or more microprocessors), digital signal processors, etc., each having one or more processor cores, interfaced with memory management device 404 and system interconnect 406. Memory management device 404 provides mappings between virtual memory used by processes being executed, and the physical memory. Memory management device 404 can be an integral part of a central processing unit which also includes the processing devices 402.

Interconnect 406 includes a backplane, link, or bus such as address, data, and control lines, as well as the interface with input/output devices, e.g., PCI, USB, etc. Memory 408 (e.g., dynamic random access memory—DRAM) and non-volatile memory 409 such as flash memory (e.g., electrically-erasable read-only memory—EEPROM, NAND Flash, NOR Flash, etc.) are interfaced with memory management device 404 and interconnect 406 via memory controller 410. This architecture may support direct memory access (DMA) by peripherals in some embodiments. I/O devices, including graphics processing, video and audio adapters, non-volatile storage, external peripheral links such as USB, Bluetooth, etc., as well as network interface devices such as those communicating via Wi-Fi or LTE-family interfaces, are collectively represented as I/O devices and networking 412, which interface with interconnect 406 via corresponding I/O controllers 414.

FIG. 5 is a block diagram illustrating the security engine of the mobile device depicted in FIG. 3 according to some embodiments. In one type of embodiment, security engine 318 is implemented using distinct hardware components from processing system 304. In one example, security engine 318 is implemented with a system-on-chip (SoC) device that includes a processor core, data storage, and input/output facilities, integrated on a single integrated circuit (IC) die.

In other embodiments (not shown in FIG. 3), security engine 318 may be incorporated as part of processing system 304, though the data storage and processing operations of security engine 318 remain isolated, e.g., inaccessible to other parts of processing system 304. In one such embodiment, security engine 318 is realized using processing system 304 configured to execute a specific portion of the code of a unified extensible firmware interface (UEFI).

As illustrated in FIG. 5, security engine 318 includes physical isolation structure 500, along with server link isolator (SLI) engine 502, secure buffer 506, device link isolator (DLI) engine 508, and secure path setup engine 514. Physical isolation structure 500 provides isolation for the operations internal to security engine 318 from other operations performed by computing hardware 302. Physical isolation structure 500 may take any number of forms according to various embodiments. For instance, in an embodiment, security engine 318 is packaged as a distinct integrated circuit, such that the die boundary constitutes physical isolation structure 500. In other embodiments, the layout of the physical components constituting security engine 318 to provide physical separation and electrical isolation from other circuitry, achieves physical isolation structure 500.

SLI engine 502 maintains a cryptographic key 504 with which data communications with VMS server 360 are secured. SLI engine 502 further includes data processing and storage circuitry, along with executable instructions that coordinate the operation of SLI engine 502. These operations include decrypting output information from VMS server 360 that is received by mobile device 300, and, in some embodiments, encrypting local input information to be sent to VMS server 360. In a related embodiment, SLI engine 502 may maintain additional cryptographic keys (e.g., 505), with each key being associated with a different VMS server.

DLI engine 508 maintains cryptographic key 510, which is used to secure data exchange with an output device, such as a graphics processor unit (GPU) or video signal generator circuitry, or any other type of output device. In a related embodiment, DLI engine 508 may securely exchange data with one or more input devices. DLI engine 508 further includes data processing and storage circuitry, along with executable instructions that coordinate the operation of DLI engine 508. These operations include encrypting, via key 510, output information accessed from VMS server 360 (that is decrypted by SLI engine 502), and passing the encrypted output information to corresponding output device(s). In a related embodiment, DLI engine 508 may perform decryption if input information accessed from local input devices of mobile device 300.

In an embodiment, a single cryptographic key 510 is used to exchange data with one or more output or input devices. In another embodiment, DLI engine 508 maintains multiple keys (e.g., key 511) for use with different output or input devices. For the sake of clarity, the embodiment depicted in FIG. 5 shows individual cryptographic keys 504, 510, respectively, for SLI engine 502 and DLI engine 508.

Secure buffer engine 506 includes a shared data store between SLI 502 and DLI 508, which allows information to be passed from the server link to the device link, with each respective link having its own encryption regime. In such an embodiment, secure buffer 506 stores clear, i.e., non-encrypted information. In a related embodiment, SLI engine 502 uses a different encryption algorithm from DLI engine 508.

Secure path setup engine 514 includes data processing and storage circuitry, along with executable instructions that coordinate the operation of secure path setup engine 514. In some embodiments, secure path setup engine 514 maintains key-pairs for initializing secure connections with VMS server(s) and local output or input devices. Once the respective secure connections are set up, secure path setup engine 514 passes the corresponding cryptographic keys to SLI engine 502 and DLI engine 508. In a related embodiment, secure path setup engine 514 is programmed, or otherwise configured, to perform authentication of VMS server(s), interact with a certificate authority server, interact with a license server, and perform other security-related functionality. In another related embodiment, secure path setup engine 514 is programmed, or otherwise configured, to store a unique ID associated with the mobile device 300, along with additional descriptive information about mobile device 300, such as manufacturer-specific data, device-specific metadata, and the like.

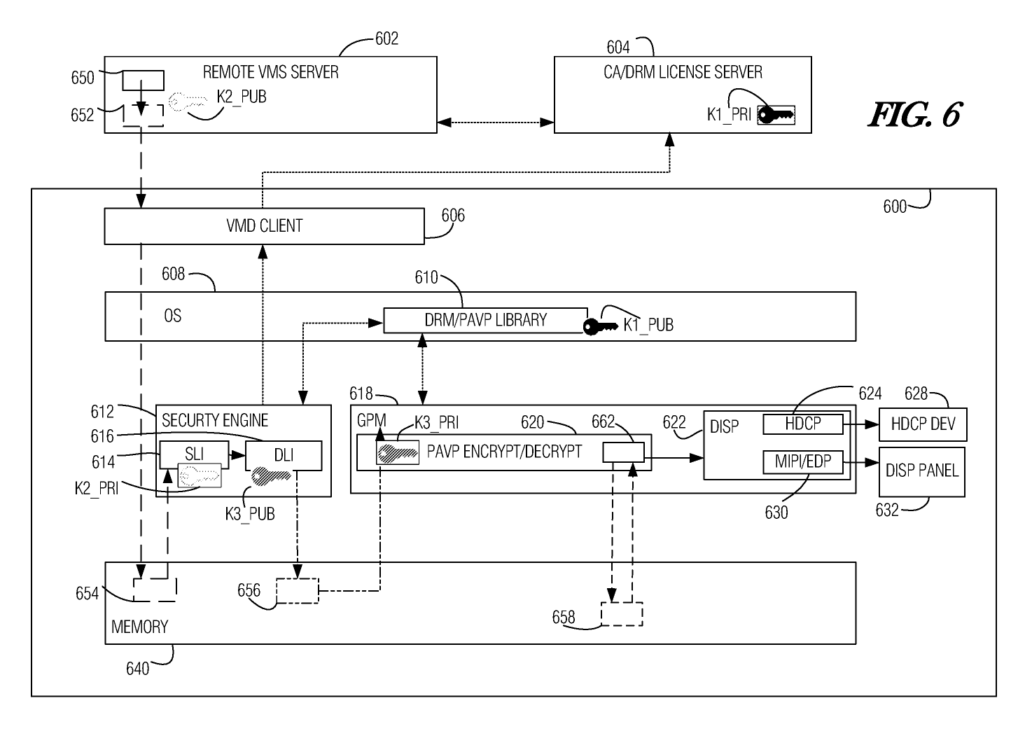

FIG. 6 is a block diagram illustrating an example system architecture of a mobile device, as well as example functionality and information flow according to some embodiments. In this example, mobile device 600 is receiving output information, namely, display output information, from remote VMS server 602. As will be described in greater detail below, mobile device 600, which may be regarded as an example embodiment of mobile device 102, 200, or 300 described above, utilizes digital rights management (DRM) and protected audio/video path (PAVP) facilities to implement portions of the engines described above.

The communication session between mobile device 600 and VMS server 602 is a secure communications path that was previously configured with a provisioning of a cryptographic key. In an example key provisioning process, a DRM key pair (e.g., public and private keys) K2_PUB and K2_PRI are preconfigured in security engine 612 at the time of manufacture or initial configuration of mobile device 600. Similarly, PAVP public and private keys K3_PUB and K3_PRI are provided at the time of manufacture or initial configuration of mobile device 600. In addition, unique device information (not shown) of mobile device 600 is configured in security engine 612.

Notably, in this embodiment, these keys are provisioned in hardware of security engine 612 that is inaccessible to OS 608, VMD client application 606, and the hardware on which OS 608 and VMD client application 606 are executed.

In the initial setup of the communication session with remote VMS server 602, security engine 612, operating under the control of VMD client 606, accesses the public key K1_PUB of certificate authority or DRM license server 604 from DRM/PAVP library 610 maintained by OS 608. Security engine 612 uses public key K1_PUB to encrypt the DRM public key K2_PUB and the unique device information, which is then passed to CA/DRM license server 604. In response, CA/DRM license server 604 authenticates mobile device 600 against unique device identification information previously provided to CA/DRM license server 604 over an off-line channel. Upon successful authentication, the DRM public key K2_PUB from security engine 612 is sent to remote VMS server 602 by CA/DRM license server 604. Henceforth, the display output information 650 is encrypted using DRM public key K2_PUB by remote VMS server 602 to produce a DRM-encrypted copy 652 of the display output information.

DRM-encrypted copy 652 of the display output information is passed from remote VMS server 602 to mobile device 600, where it is received under the control of VMD client 606 and OS 608, and stored in memory 640—as indicated at 654, while remaining inaccessible, e.g., isolated, from the processes handling DRM-encrypted copy 652 of the display output information. DRM-encrypted copy 652 of the display output information is passed to security engine 612, where it is decrypted by SLI 614. In its decrypted state, the display output information 650 is stored securely internally by security engine 612, where it remains isolated.

Next, the display output information 650 is encrypted using PAVP public key K3_PUB, and transferred to graphics processing engine 618 from DLI 616, which may include a graphics processing unit (GPU), and other circuitry for converting the display output information to a signal for transmission to the display unit itself. PAVP-encrypted display output information may be stored in memory 640, as indicated at 656, as it is passed to GPM 618. GPM 618 includes a PAVP encryption/decryption engine 620, which was configured previously with PAVP private key K3_PRI. Encryption/decryption engine 620 uses key K3_PRI to decrypt the display output information for processing. At this stage, the clear display output information 662 is isolated from OS 608 and any other process running on mobile device 600. If the display output information needs to be saved to system memory 640, it is re-encrypted by encryption/decryption engine 620, and stored as PAVP-encrypted copy 658.

Clear display output information 662, once processed, is passed to display signal generator circuit 622, which includes HDCP engine 624, MIPI/EDP engine 630, or both, for instance, each of which respectively produces display signal for reception by a HDCP device 628 or display panel 632, respectively.

It will be appreciated that in other various embodiments, the cryptographic operations may be varied substantially, so long as the display output information is isolated from OS 608 and the other processes. For instance, a scheme that uses symmetric keys, rather than a public key cryptosystem, may be suitably utilized. In other related embodiments, encryption processes other than DRM and PAVP may be employed. In another related embodiment, security engine 612 may be incorporated with GPM 618, and may use an electrically-isolated path isolated from the other hardware of mobile device 600 to transfer clear display output information to display signal generator circuit 622; this approach may obviate the need for a second encryption process that would otherwise use key(s) K3. It will also be appreciated that in related embodiments, input information may be handled in a similar fashion as described above for the display output information—i.e., with end-to-end encryption between the input device(s) and security engine 612, or electrically-isolated data paths.

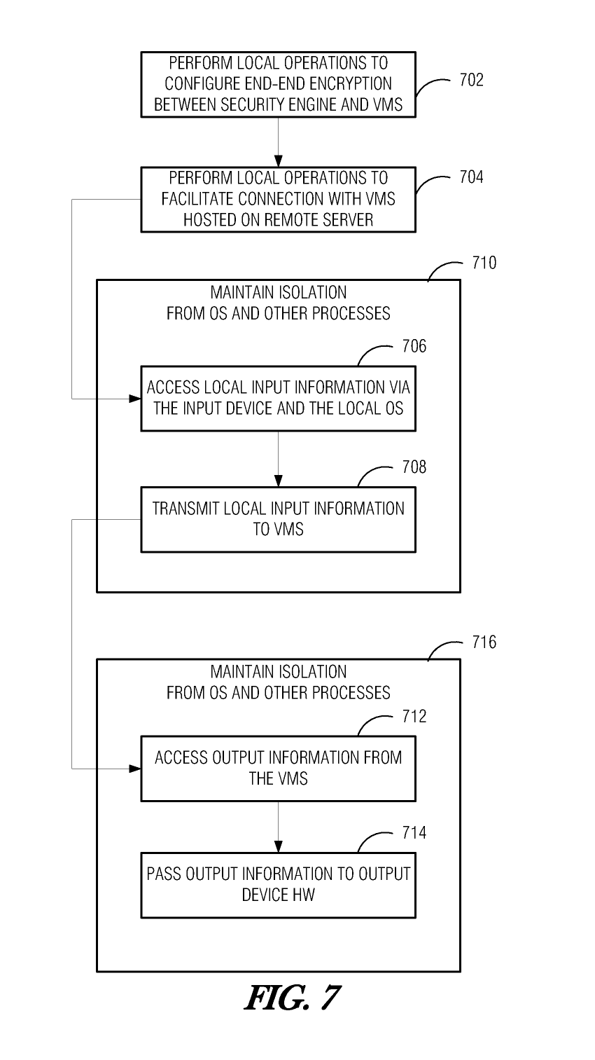

FIG. 7 is a flow diagram illustrating an example process for operation of a mobile device according to some embodiments. At 702, end-to-end encryption between a security engine of the mobile device and the VMS is configured by local operations performed by the mobile device. It will be understood that the server on which the VMS is hosted also performs local operations to facilitate the end-to-end security. The end-to-end encryption may be accomplished, for example, as discussed above with a key exchange process according to certain embodiments. At 704, the mobile device performs local operations to facilitate a connection with the VMS on the remote server. Likewise, the server hosting the VMS will perform counterpart operations on its end to facilitate the connection. At 706, the mobile device accesses local input information via one or more input devices of the mobile device operating under control of the local operating system executing on the mobile device. At 708, the local input information is transmitted to the VMS. As illustrated at 710, operations 706 and 708 are performed in such a way that the local input information is isolated from the OS and other processes running on the mobile device.

At 712, the mobile device accesses output information from the VMS and, at 714, the output information is passed to the output device hardware of the mobile device. As indicated at 716, operations 712 and 714 are performed such that the output information is isolated from the OS and other processes running on the mobile device.

It should be noted that, in those embodiments in which only the output information is isolated, the information exchange between the user and the VMS may remain secure, even if the local input information is not isolated from the OS or other processes. This may be accomplished in some embodiments by the use of true-random, or pseudo-random techniques to obfuscate the meaning of the registered user inputs. For example, data entry may be achieved by the use a touchscreen on which the data is entered by user manipulation of a graphically-displayed input object, such as a knob or dial. Each knob or dial may have a random or pseudo-randomized starting point, such that the user's touch inputs, in the absence of knowledge about the graphically-displayed input object, are effectively meaningless. Such a data entry process may be selectively employed by the VMS for the entry of critical information by the user, such as passwords, PINs, sensitive personal information, or the like.

### Additional Notes & Examples

Example 1 is a system for implementing an isolated remotely-virtualized computing environment on a mobile device, the system comprising: computing hardware including an input device, an output device, a network interface device (NID), and a processing system having at least one data store; the computing hardware containing instructions that, when executed, cause the computing hardware to implement an isolated computing environment engine to: perform operations to facilitate a connection with a virtualized mobile system (VMS) implemented on a remote server; access local input information via the input device and a local operating system (OS), and transmit the local input information via the NID to the VMS; access, via the NID, output information from the VMS and pass the output information to be accessed by the output device; and maintain isolation of the output information, wherein content of the output information is inaccessible by the local OS and at least one other local process executed on the computing hardware under control of the local OS

In Example 2, the subject matter of Example 1 optionally includes, wherein the output information from the VMS includes streaming graphical display content.

In Example 3, the subject matter of any one or more of Examples 1-2 optionally include, wherein the output information from the VMS includes streaming audio content.

In Example 4, the subject matter of any one or more of Examples 1-3 optionally include, wherein the output information from the VMS includes output content from a remote operating system shell executed on the VMS.

In Example 5, the subject matter of any one or more of Examples 1-4 optionally include, wherein the output information from the VMS includes output content from a remote operating system that is an Android-based operating system.

In Example 6, the subject matter of any one or more of Examples 1-5 optionally include, wherein the output information from the VMS includes output content from a remote operating system that is an iOS-based operating system.

In Example 7, the subject matter of any one or more of Examples 1-6 optionally include, wherein the local input information includes touchscreen input.

In Example 8, the subject matter of any one or more of Examples 1-7 optionally include, wherein the local input information includes a video capture stream.

In Example 9, the subject matter of any one or more of Examples 1-8 optionally include, wherein the local input information includes sensor-captured data of the mobile device.

In Example 10, the subject matter of any one or more of Examples 1-9 optionally include, wherein the isolated computing environment engine is configured to maintain isolation of the input information wherein content of the input information is inaccessible by the OS and the at least one other local process.

In Example 11, the subject matter of any one or more of Examples 1-10 optionally include, wherein the isolated computing environment engine includes a thin client application to be executed on the computing hardware.

In Example 12, the subject matter of any one or more of Examples 1-11 optionally include, wherein the isolated computing environment engine is to access the output information in a first encrypted form, wherein the first encrypted form is encrypted exclusively for access by the isolated computing environment engine.

In Example 13, the subject matter of any one or more of Examples 1-12 optionally include, wherein the isolated computing environment engine is to pass the output information to be accessed by the output device via the local OS.

In Example 14, the subject matter of any one or more of Examples 1-13 optionally include, wherein the isolated computing environment engine is to maintain the isolation of the output information by keeping the output information in an encrypted form whenever the output information is stored in the at least one data store.

In Example 15, the subject matter of any one or more of Examples 1-14 optionally include, wherein the isolated computing environment engine is to maintain the isolation of the output information by establishment of a first secure data path with the VMS and a second secure data path with the output device, and by transferring the output information from the first data path to the second data path.

In Example 16, the subject matter of Example 15 optionally includes, wherein the first secure data path includes end-to-end encryption between the VMS and the isolated computing environment engine.

In Example 17, the subject matter of any one or more of Examples 15-16 optionally include, wherein the second secure data path includes end-to-end encryption between the isolated computing environment engine with the output device.

In Example 18, the subject matter of any one or more of Examples 15-17 optionally include, wherein the second secure data path includes a device driver corresponding to the output device.

In Example 19, the subject matter of any one or more of Examples 1-18 optionally include, wherein the isolated computing environment engine is to maintain the isolation of the output information by operation of a digital rights management (DRM) framework and a protected audio/video path (PAVP) framework of the local mobile device.

In Example 20, the subject matter of any one or more of Examples 1-19 optionally include, wherein the isolated computing environment engine is to maintain the isolation of the output information by establishment of an asymmetrical key pair with the VMS.

In Example 21, the subject matter of any one or more of Examples 1-20 optionally include, wherein the isolated computing environment engine includes: a security engine to perform decryption of the output information, the security engine being isolated from the computing hardware; a communications handler engine to control information flow between the local OS and the VMS; an output device handler to control information flow of the output information between the local OS and the security engine.

Example 22 is at least one computer-readable medium containing instructions that, when executed by a mobile device that includes computing hardware, an input device, an output device, at least one data store, and an isolated computing device, cause the mobile device to: perform operations to facilitate a connection with a virtualized mobile system (VMS) implemented on a remote server; access local input information via the input device, and transmitting the local input information to the VMS; access output information from the VMS, and passing the output information to be accessed by the output device; and maintain isolation within the mobile device of the output information, wherein content of the output information is inaccessible by an operating system (OS) and local processes executing on the computing hardware

In Example 23, the subject matter of Example 22 optionally includes, wherein the instructions that cause the mobile device to access the output information from the VMS include instructions for accessing streaming graphical display content.

In Example 24, the subject matter of any one or more of Examples 22-23 optionally include, wherein the instructions that cause the mobile device to access the output information from the VMS include instructions for accessing streaming audio content.

In Example 25, the subject matter of any one or more of Examples 22-24 optionally include, wherein the instructions that cause the mobile device to access the output information from the VMS include instructions for accessing output content from a remote operating system shell executed on the VMS.

In Example 26, the subject matter of any one or more of Examples 22-25 optionally include, wherein the instructions that cause the mobile device to access the output information from the VMS include instructions for accessing output content from a remote operating system that is an Android-based operating system.

In Example 27, the subject matter of any one or more of Examples 22-26 optionally include, wherein the instructions that cause the mobile device to access the output information from the VMS include instructions for accessing output content from a remote operating system that is an iOS-based operating system.

In Example 28, the subject matter of any one or more of Examples 22-27 optionally include, wherein the instructions that cause the mobile device to access the local input information includes instructions for accessing touchscreen input.

In Example 29, the subject matter of any one or more of Examples 22-28 optionally include, wherein the instructions that cause the mobile device to access the local input information includes instructions for accessing a video capture stream.

In Example 30, the subject matter of any one or more of Examples 22-29 optionally include, wherein the instructions that cause the mobile device to access the local input information includes instructions for accessing sensor-captured data of the mobile device.

In Example 31, the subject matter of any one or more of Examples 22-30 optionally include, further comprising: instructions for causing the mobile device to maintain isolation within the mobile device of the input information, wherein content of the input information is inaccessible by the OS and the local processes.

In Example 32, the subject matter of any one or more of Examples 22-31 optionally include, wherein the local processes include a thin client application executing on the mobile device.

In Example 33, the subject matter of any one or more of Examples 22-32 optionally include, wherein the output is accessed in a first encrypted form to facilitate maintaining the isolation.

In Example 34, the subject matter of any one or more of Examples 22-33 optionally include, wherein the isolation of the output information is maintained during passing of the output information to be accessed by the output device via the OS.

In Example 35, the subject matter of any one or more of Examples 22-34 optionally include, wherein the instructions that cause the mobile device to maintain isolation of the output information include instructions for keeping the output information in an encrypted form whenever the output information is stored in the at least one data store accessible to the OS or the local processes.

In Example 36, the subject matter of any one or more of Examples 22-35 optionally include, wherein the instructions that cause the mobile device to maintain isolation of the output information include instructions for establishment of a first secure data path between the VMS and isolated computing device, and a second secure data path between the isolated computing device and the output device, and instructions for transferring the output information from the first data path to the second data path.

In Example 37, the subject matter of Example 36 optionally includes, wherein the first secure data path includes end-to-end encryption between the VMS and the isolated computing device interfaced with the output device.

In Example 38, the subject matter of any one or more of Examples 36-37 optionally include, wherein the second secure data path includes end-to-end encryption between the isolated computing device and the output device.

In Example 39, the subject matter of any one or more of Examples 36-38 optionally include, wherein the second secure data path includes a device driver corresponding to the output device.

In Example 40, the subject matter of any one or more of Examples 22-39 optionally include, wherein the instructions that cause the mobile device to maintain isolation of the output information include instructions for operation of a digital rights management (DRM) framework and a protected audio/video path (PAVP) framework of the mobile device.

In Example 41, the subject matter of any one or more of Examples 22-40 optionally include, wherein the instructions that cause the mobile device to maintain isolation of the output information include: instructions for performing decryption of the output information by the isolated computing device; instructions for controlling information flow between the OS and the VMS; and instructions for controlling information flow of the output information between the OS and isolated computing device.

Example 42 is a method for operating an isolated remotely-virtualized computing environment on a mobile device that includes computing hardware, an input device and an output device, the computing hardware executing an operating system (OS) and local processes, the method comprising: performing operations, by the mobile device, to facilitate a connection with a virtualized mobile system (VMS) implemented on a remote server; accessing, by the mobile device, local input information via the input device, and transmitting the local input information to the VMS; accessing, by the mobile device, output information from the VMS, and passing the output information to be accessed by the output device; and maintaining isolation within the mobile device of the output information, wherein content of the output information is inaccessible by the OS and the local processes

In Example 43, the subject matter of Example 42 optionally includes, wherein accessing the output information from the VMS includes accessing streaming graphical display content.

In Example 44, the subject matter of any one or more of Examples 42-43 optionally include, wherein accessing the output information from the VMS includes accessing streaming audio content.

In Example 45, the subject matter of any one or more of Examples 42-44 optionally include, wherein accessing the output information from the VMS includes accessing output content from a remote operating system shell executed on the VMS.

In Example 46, the subject matter of any one or more of Examples 42-45 optionally include, wherein accessing the output information from the VMS includes accessing output content from a remote operating system that is an Android-based operating system.

In Example 47, the subject matter of any one or more of Examples 42-46 optionally include, wherein accessing the output information from the VMS includes accessing output content from a remote operating system that is an iOS-based operating system.

In Example 48, the subject matter of any one or more of Examples 42-47 optionally include, wherein accessing the local input information includes accessing touchscreen input.

In Example 49, the subject matter of any one or more of Examples 42-48 optionally include, wherein accessing the local input information includes accessing a video capture stream.

In Example 50, the subject matter of any one or more of Examples 42-49 optionally include, wherein accessing the local input information includes accessing sensor-captured data of the mobile device.

In Example 51, the subject matter of any one or more of Examples 42-50 optionally include, further comprising: maintaining isolation within the mobile device of the input information, wherein content of the input information is inaccessible by the OS or the local processes.

In Example 52, the subject matter of any one or more of Examples 42-51 optionally include, wherein the local processes include a thin client application executing on the mobile device.

In Example 53, the subject matter of any one or more of Examples 42-52 optionally include, wherein the output is accessed in a first encrypted form to facilitate maintaining the isolation.

In Example 54, the subject matter of any one or more of Examples 42-53 optionally include, wherein the isolation of the output information is maintained during passing of the output information to be accessed by the output device via the OS.

In Example 55, the subject matter of any one or more of Examples 42-54 optionally include, wherein the isolation of the output information is maintained by keeping the output information in an encrypted form whenever the output information is stored in the computing hardware accessible to the OS and other processes.

In Example 56, the subject matter of any one or more of Examples 42-55 optionally include, wherein the isolation of the output information is maintained by establishment of a first secure data path between the VMS and an isolated computing environment engine, and a second secure data path between the isolated computing environment engine and the output device, and by transferring the output information from the first data path to the second data path.

In Example 57, the subject matter of Example 56 optionally includes, wherein the first secure data path includes end-to-end encryption between the VMS and the isolated computing environment engine interfaced with the output device.

In Example 58, the subject matter of any one or more of Examples 56-57 optionally include, wherein the second secure data path includes end-to-end encryption between the isolated computing environment engine and the output device.

In Example 59, the subject matter of any one or more of Examples 56-58 optionally include, wherein the second secure data path includes a device driver corresponding to the output device.

In Example 60, the subject matter of any one or more of Examples 42-59 optionally include, wherein the isolation of the output information is maintained by operation of a digital rights management (DRM) framework and a protected audio/video path (PAVP) framework of the mobile device.

In Example 61, the subject matter of any one or more of Examples 42-60 optionally include, the isolation of the output information is maintained by: performing decryption of the output information by a security engine isolated from the computing hardware; controlling information flow between the OS and the VMS; and controlling information flow of the output information between the OS and the security engine.

Example 62 is a system for operating an isolated remotely-virtualized computing environment on a mobile device that includes computing hardware, an input device and an output device, the computing hardware executing an operating system (OS) and local processes, the system comprising: means for connecting, by the mobile device, with a virtualized mobile system (VMS) implemented on a remote server; means for accessing, by the mobile device, local input information via the input device, and transmitting the local input information to the VMS; means for accessing, by the mobile device, output information from the VMS, and passing the output information to be accessed by the output device; and means for maintaining isolation within the mobile device of the output information, wherein content of the output information is inaccessible by the OS and the local processes

In Example 63, the subject matter of Example 62 optionally includes, wherein the means for accessing the output information from the VMS includes means for accessing streaming graphical display content.

In Example 64, the subject matter of any one or more of Examples 62-63 optionally include, wherein the means for accessing the output information from the VMS includes means for accessing streaming audio content.

In Example 65, the subject matter of any one or more of Examples 62-64 optionally include, wherein the means for accessing the output information from the VMS includes means for accessing output content from a remote operating system shell executed on the VMS.

In Example 66, the subject matter of any one or more of Examples 62-65 optionally include, wherein the means for accessing the output information from the VMS includes means for accessing output content from a remote operating system that is an Android-based operating system.

In Example 67, the subject matter of any one or more of Examples 62-66 optionally include, wherein the means for accessing the output information from the VMS includes means for accessing output content from a remote operating system that is an iOS-based operating system.

In Example 68, the subject matter of any one or more of Examples 62-67 optionally include, wherein the means for accessing the local input information includes means for accessing touchscreen input.

In Example 69, the subject matter of any one or more of Examples 62-68 optionally include, wherein the means for accessing the local input information includes means for accessing a video capture stream.

In Example 70, the subject matter of any one or more of Examples 62-69 optionally include, wherein the means for accessing the local input information includes means for accessing sensor-captured data of the mobile device.

In Example 71, the subject matter of any one or more of Examples 62-70 optionally include, further comprising: means for maintaining isolation within the mobile device of the input information, wherein content of the input information is inaccessible by the OS and the local processes.

In Example 72, the subject matter of any one or more of Examples 62-71 optionally include, wherein the local processes include a thin client application executing on the mobile device.

In Example 73, the subject matter of any one or more of Examples 62-72 optionally include, wherein the output is accessed in a first encrypted form to facilitate maintaining the isolation.

In Example 74, the subject matter of any one or more of Examples 62-73 optionally include, wherein the isolation of the output information is maintained during passing of the output information to be accessed by the output device via the OS.

In Example 75, the subject matter of any one or more of Examples 62-74 optionally include, wherein the means for maintaining isolation of the output information include means for keeping the output information in an encrypted form whenever the output information is stored in the computing hardware accessible to the OS and other processes.

In Example 76, the subject matter of any one or more of Examples 62-75 optionally include, wherein the means for maintaining isolation of the output information include means for establishment of a first secure data path between the VMS and means for performing isolated computing, and a second secure data path between the means for performing isolated computing and the output device, and by transferring the output information from the first data path to the second data path.

In Example 77, the subject matter of Example 76 optionally includes, wherein the first secure data path includes end-to-end encryption between the VMS and the means for performing isolated computing interfaced with the output device.

In Example 78, the subject matter of any one or more of Examples 76-77 optionally include, wherein the second secure data path includes end-to-end encryption between the means for performing isolated computing and the output device.

In Example 79, the subject matter of any one or more of Examples 76-78 optionally include, wherein the second secure data path includes a device driver corresponding to the output device.

In Example 80, the subject matter of any one or more of Examples 62-79 optionally include, wherein the means for maintaining isolation of the output information include means for operation of a digital rights management (DRM) framework and a protected audio/video path (PAVP) framework of the mobile device.

In Example 81, the subject matter of any one or more of Examples 62-80 optionally include, the means for maintaining isolation of the output information include: means for performing decryption of the output information by a security engine isolated from the computing hardware; means for controlling information flow between the OS and the VMS; and means for controlling information flow of the output information between the OS and means for performing isolated computing.

In Example 82, the subject matter of any one or more of Examples 42-81 optionally include At least one computer-readable medium containing instructions that, when executed by a mobile device that includes computing hardware, an input device, an output device, at least one data store, and an isolated computing device, cause the mobile device to: perform operations to facilitate execution of the method according to any one of Examples 42-61.

In Example 83, the subject matter of any one or more of Examples 42-82 optionally include An apparatus for implementing an isolated remotely-virtualized computing environment on a mobile device, comprising: means for performing operations facilitating execution of the method according to any one of Examples 42-61.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. A system for implementing an isolated remotely-virtualized computing environment on a mobile device, the system comprising:
computing hardware including an input device, an output device, a network interface device (NID), and a processing system having at least one data store;
the computing hardware containing instructions that, when executed, cause the computing hardware to implement an isolated computing environment engine to:
perform operations to facilitate a connection with a virtualized mobile system (VMS) implemented on a remote server;
access local input information via the input device and a local operating system (OS), and transmit the local input information via the NID to the VMS;
access, via the NID, output information from the VMS and pass the output information to be accessed by the output device; and
maintain isolation of the output information, wherein content of the output information is inaccessible by the local OS and at least one other local process executed on the computing hardware under control of the local OS.

27. The system of claim 26, wherein the output information from the VMS includes output content from a remote operating system shell executed on the VMS.

28. The system of claim 26, wherein the local input information includes touchscreen input.

29. The system of claim 26, wherein the local input information includes sensor-captured data of the mobile device.

30. The system of claim 26, wherein the isolated computing environment engine is configured to maintain isolation of the input information wherein content of the input information is inaccessible by the OS and the at least one other local process.

31. The system of claim 26, wherein the isolated computing environment engine includes a thin client application to be executed on the computing hardware.

32. The system of claim 26, wherein the isolated computing environment engine is to access the output information in a first encrypted form, wherein the first encrypted form is encrypted exclusively for access by the isolated computing environment engine.

33. The system of claim 26, wherein the isolated computing environment engine is to pass the output information to be accessed by the output device via the local OS.

34. The system of claim 26, wherein the isolated computing environment engine is to maintain the isolation of the output information by keeping the output information in an encrypted form whenever the output information is stored in the at least one data store.

35. The system of claim 26, wherein the isolated computing environment engine is to maintain the isolation of the output information by establishment of a first secure data path with the VMS and a second secure data path with the output device, and by transferring the output information from the first data path to the second data path.

36. The system of claim 26, wherein the isolated computing environment engine includes:
a security engine to perform decryption of the output information, the security engine being isolated from the computing hardware;
a communications handler engine to control information flow between the local OS and the VMS;
an output device handler to control information flow of the output information between the local OS and the security engine.

37. At least one non-transitory computer-readable storage medium containing instructions that, when executed by a mobile device that includes computing hardware, an input device, an output device, at least one data store, and an isolated computing device, cause the mobile device to:
perform operations to facilitate a connection with a virtualized mobile system (VMS) implemented on a remote server;
access local input information via the input device, and transmitting the local input information to the VMS;
access output information from the VMS, and passing the output information to be accessed by the output device; and
maintain isolation within the mobile device of the output information, wherein content of the output information is inaccessible by an operating system (OS) and local processes executing on the computing hardware.

38. The at least one computer-readable medium of claim 37, further comprising:
instructions for causing the mobile device to maintain isolation within the mobile device of the input information, wherein content of the input information is inaccessible by the OS and the local processes.

39. The at least one computer-readable medium of claim 37, wherein the isolation of the output information is maintained during passing of the output information to be accessed by the output device via the OS.

40. The at least one computer-readable medium of claim 37, wherein the instructions that cause the mobile device to maintain isolation of the output information include instructions for keeping the output information in an encrypted form whenever the output information is stored in the at least one data store accessible to the OS or the local processes.

41. The at least one computer-readable medium of claim 37, wherein the instructions that cause the mobile device to maintain isolation of the output information include instructions for establishment of a first secure data path between the VMS and isolated computing device, and a second secure data path between the isolated computing device and the output device, and instructions for transferring the output information from the first data path to the second data path.

42. A method for operating an isolated remotely-virtualized computing environment on a mobile device that includes computing hardware, an input device and an output device, the computing hardware executing an operating system (OS) and local processes, the method comprising:
performing operations, by the mobile device, to facilitate a connection with a virtualized mobile system (VMS) implemented on a remote server;
accessing, by the mobile device, local input information via the input device, and transmitting the local input information to the VMS;
accessing, by the mobile device, output information from the VMS, and passing the output information to be accessed by the output device; and
maintaining isolation within the mobile device of the output information, wherein content of the output information is inaccessible by the OS and the local processes.

43. The method of claim 42, wherein accessing the output information from the VMS includes accessing output content from a remote operating system that is an iOS-based operating system.

44. The method of claim 42, further comprising:
maintaining isolation within the mobile device of the input information, wherein content of the input information is inaccessible by the OS or the local processes.

45. The method of claim 42, wherein the local processes include a thin client application executing on the mobile device.

46. The method of claim 42, wherein the output is accessed in a first encrypted form to facilitate maintaining the isolation.

47. The method of claim 42, wherein the isolation of the output information is maintained during passing of the output information to be accessed by the output device via the OS.

48. The method of claim 42, wherein the isolation of the output information is maintained by keeping the output information in an encrypted form whenever the output information is stored in the computing hardware accessible to the OS and other processes.

49. The method of claim 42, wherein the isolation of the output information is maintained by establishment of a first secure data path between the VMS and an isolated computing environment engine, and a second secure data path between the isolated computing environment engine and the output device, and by transferring the output information from the first data path to the second data path.

50. The method of claim 42, the isolation of the output information is maintained by:
performing decryption of the output information by a security engine isolated from the computing hardware;
controlling information flow between the OS and the VMS; and
controlling information flow of the output information between the OS and the security engine.
